(19) United States
(12) Patent Application Publication
(10) Pub. No.: US 2002/0080266 A1
(43) Pub. Date: Jun. 27, 2002

(54) Method of manufacture of a solid state image pickup device, and a flexible printed wiring board

(76) Inventors: Kohji Shinomiya, Tokyo (JP); Yukio Oda, Tokyo (JP)

Correspondence Address: LEYDIG VOIT & MAYER, LTD, 700 THIRTEENTH ST. NW, SUITE 300, WASHINGTON, DC, 20005-3960, US

(21) Appl. No.: 09/814,825

(22) Filed: Mar. 23, 2001

(30) Foreign Application Priority Data
Nov. 7, 2000 (JP) 2000-338832

(51) Int. Cl. H04N 5/225; H04N 17/00

(52) U.S. Cl. 348/374; 348/187

(57) ABSTRACT

When manufacturing a solid state image pickup device, a dedicated terminal for electric test and an image pickup area are provided in fixed positions on a common flexible printed wiring board. The electric image pickup test is carried out and, after its completion, the solid state image pickup device is taken out and the terminal for electric test is removed.

### FIELD OF THE INVENTION

The present invention in general relates to a method of manufacturing a solid state image pickup device and a flexible printed wiring board. The solid state image pickup device has a solid state image pickup element and an optical system casing including an optical lens. More particularly, this invention relates to a method of manufacturing a solid state image pickup device on which an electric test such as an electric image pickup test can be easily carried out irrespective of the shape of a substrate.

### BACKGROUND OF THE INVENTION

FIG. 8 is an external view of an example of a conventional solid state image pickup device. FIG. 10 is an external view of a solid state image pickup device of another form. In these figures, legend 1 denotes a flexible printed wiring board (hereafter, FPC) made of a film material such as polyimide. There figures show a state in which an optical system casing 13 is bent forward. Connection terminals 3a and 3b are provided at one end of the FPC 1 and they are used for connecting the solid state image pickup device to an external device. An optical system casing 13 holds an optical lens, an optical filter, and the like. A diaphragm 8 controls the amount of incoming light. FIG. 9 shows a state in which the FPC 1 shown in FIG. 8 is spread. FIG. 11 shows a state in which the FPC 1 shown in FIG. 10 is spread.

FIG. 12 and FIG. 13 are for explaining the conventional method of carrying out an electric image pickup test on the conventional solid state image pickup devices shown in FIG. 8 to FIG. 10. When carrying the electric image pickup test, as shown in FIG. 12, an electric image pickup tester 23 is connected to the solid state image pickup device through the connection terminal 3a, electric connection socket 21a, and lead 22a for test. Similarly, when carrying the electric image pickup test, as shown in FIG. 13, the electric image pickup tester 23 is connected to the solid state image pickup device through the connection terminal 3b, electric connection socket 21b, and lead 22b for test. Although not shown in these figures, a plurality of test image charts are separately provided on the outside. The optical system casing 13 is positioned so that a test image pickup can be performed while switching the test image charts. Consequently, after image pickup light is allowed to enter the diaphragm 8 and a state where image pickup can be performed is obtained, an electric image pickup test is carried out. The solid state image pickup device receives power from the electric image pickup tester 23 through the lead 22a or 22b for test, electric connection socket 21a or 21b, connection terminal 3a or 3b and becomes ready for operation. When the solid state image pickup device becomes ready for operation, image pickup light comes in through the diaphragm 8 and an image of a test image chart can be picked up.

The flowchart in FIG. 14 explains various steps in the conventional manufacturing method of the solid state image pickup device. A single side coppered or double side coppered flexible board is first subjected to etching of a circuit pattern of a product, thereby forming a flexible printed wiring board. The flexible printed wiring board is processed in the shape of the product. After that, attachment of chip parts, flip chip bonding of the solid state image pickup element, flip chip bonding of an IC part (chip) for signal processing or the like as necessary, and attachment of an optical system casing including a fixing seating, a fixing cap, an optical lens, an optical filter, and a diagram are performed. Subsequently, an external connection terminal provided at an end of a lead of the flexible printed wiring board is manually attached to an electric connector and is set. The electric connector is connected to an electric image pickup tester, an image of a test image chart is picked up by the solid state image pickup device and, simultaneously, an electric image pickup test is carried out. A product which has passed the test is put in a conductive vinyl bag for shipping or the like and is shipped.

As described above, in the solid state image pickup device, various shapes of substrates adapted to designs and functions of a portable telephone, a portable terminal, and the like to which the apparatus is applied are requested. Consequently, in spite of increase in the kinds of shapes of the lead and the connector of a flexible printed wiring board and the number of terminals, conventionally, test jigs and carriage jigs are prepared so as to be adapted to the shapes and the number to conduct an electric image pickup test.

Since the conventional solid state image pickup device is manufactured in such a manner, the shapes of leads, the shapes of connectors, and the number of terminals in a flexible printed wiring board are various. A test jig for carrying out the electric image pickup test adapted to the shape of each solid state image pickup device is needed. Consequently, there are problems such that the cost increases or a manual work is necessary, and mass production of a portable telephone and the like cannot be performed. Since the ratio of labor cost to product cost is high, it is difficult to realize a lower price of the apparatus.

### SUMMARY OF THE INVENTION

It is an object of the present invention to provide a method of manufacture of a solid state image pickup device, in which solid state image pickup device an electric image pickup test can be conducted irrespective of the shapes of a lead and a connector and the number of terminals in a flexible printed wiring board, on which flexible printed wiring board the solid state image pickup device mounted. It is also an object of the present invention to provide the flexible printed wiring board on which flexible printed wiring board the solid state image pickup device mounted.

It is an another object of the present invention to provide a method of manufacture of a solid state image pickup device, in which solid state image pickup device a test jig and a carriage jig used during a manufacturing process are commonly used irrespective of shapes of a lead and a connector and the number of terminals in the flexible printed wiring board.

The method of manufacture of a solid state image pickup device according to one aspect of the present invention comprises following steps. The solid state image pickup element and the optical system casing is mounted on a common flexible printed wiring board. A dedicated terminal to be used when performing the electric test is provided on the common flexible printed wiring board. The electric test is carried out, and after its completion, the dedicated terminal is removed.

Furthermore, it is preferable that the solid state image pickup element is attached to a fixed position on the common flexible printed wiring board irrespective of the shape of the solid state image pickup device.

Furthermore, it is preferable that the terminal for electric test is attached to a fixed position on the common flexible printed wiring board irrespective of the shape of the solid state image pickup device.

Furthermore, it is preferable that a test jig used at the time of carrying out the electric test can be also used as a jig for carriage.

Furthermore, it is preferable that the jig for carriage which can be also used as the test jig has a recess in a portion of the optical system casing to fix the solid state image pickup device.

Furthermore, it is preferable that the jig for carriage which can be also used as the test jig separately has a cover and fixes the solid state image pickup device so as to sandwich the solid state image pickup device by the jig and the cover.

Other objects and features of this invention will become apparent from the following description with reference to the accompanying drawings.

The flexible printed wiring board according to another aspect of the present invention comprises at least one solid state image pickup device mounted thereon. The solid state image pickup device having a solid state image pickup element and an optical system casing mounted on the flexible printed wiring board; a terminal prepared on the flexible printed wiring board, which terminal is exclusively used when performing an electric test; and cutting lines marked on the flexible printed wiring board. The cutting lines are marked in such a manner that, when cut along these cutting lines, the flexible printed wiring board can be divided into at least portion(s) corresponding to each mounted solid state image pickup device, and a portion that includes the terminal used when performing an electric test.

### BRIEF DESCRIPTION OF THE DRAWINGS

FIG. 1 is a flowchart which explains various steps in the method of manufacture of the solid state image pickup device according to a first embodiment of the present invention.

FIG. 2 is a plan view of an FPC according to a second embodiment of the present invention.

FIG. 3 is a plan view of an FPC according to a third embodiment of the present invention.

FIG. 4 is a plan view of a common FPC according to the first embodiment.

FIG. 5 is a schematic view of an electric image pickup tester of the invention.

FIG. 6 is a plan view in which an FPC is mounted on a tray in a fourth embodiment of the invention.

FIG. 7 is a plan view of a common FPC according to a fifth embodiment of the invention.

FIG. 8 is an external view of a conventional solid state image pickup device.

FIG. 9 is a spread view of the conventional solid state image pickup device.

FIG. 10 is an external view of a conventional solid state image pickup device.

FIG. 11 is a spread view of the conventional solid state image pickup device.

FIG. 12 is a schematic view of an electric image pickup tester for a conventional solid state image pickup device.

FIG. 13 is a schematic view of an electric image pickup tester for a conventional solid state image pickup device.

FIG. 14 is a flowchart which explains various steps in the conventional method of manufacture of the solid state image pickup device.

### DESCRIPTION OF THE PREFERRED EMBODIMENTS

Preferred embodiments of the method of manufacture of the solid state image pickup device according to the present invention are explained below with reference to the attached drawings.

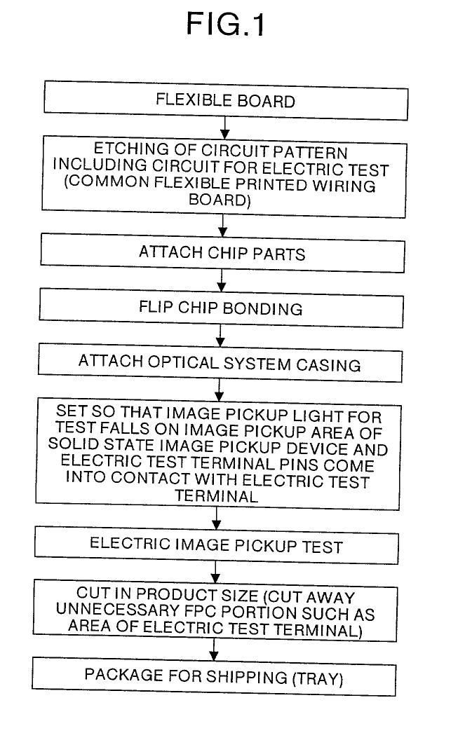

FIG. 1 explains various steps in the method of manufacture of the solid state image pickup device according to a first embodiment of the present invention. A single side coppered or double side coppered flexible board is subjected to etching of a circuit pattern including a circuit for electric test, thereby obtaining a common flexible printed wiring board.

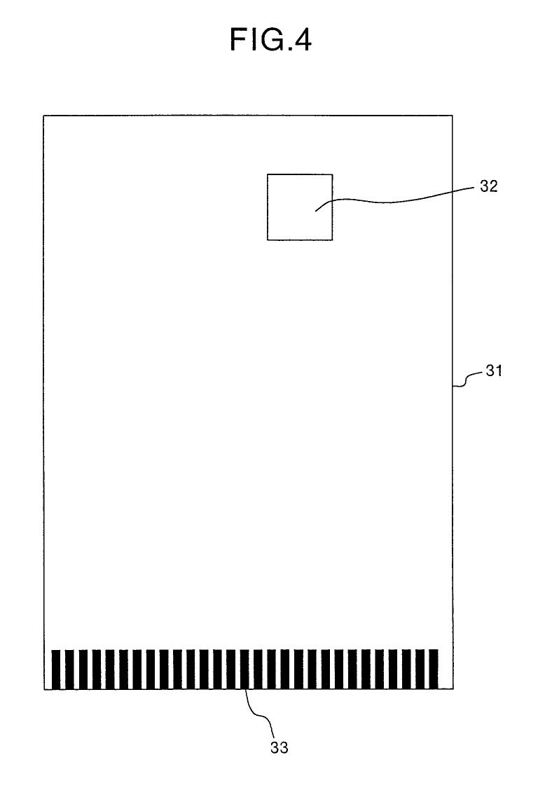

The common flexible printed wiring board denotes a flexible printed wiring board which covers all the shapes of flexible printed wiring boards of various product shapes and in which a terminal for an electric test and an image pickup area of a solid state image pickup element are commonly provided in fixed positions. FIG. 4 shows a specific example.

After that, attachment of chip parts, flip chip bonding of the solid state image pickup element, flip chip bonding of IC parts (chip) for signal processing or the like as necessary, and attachment of an optical system casing including a fixing seating, a fixing cap, an optical lens, an optical filter, and a diaphragm are performed.

It is set so that image pickup light for a test falls on the image pickup area of the solid state image pickup element and electric test terminal pins come into contact with the terminal for electric test. The electric test terminal pins are connected to an electric image pickup tester, the image of a test image chart is picked up by the solid state image pickup device and, simultaneously, an electric image pickup test is conducted. A portion unnecessary as a product in the FPC such as the area of the electric test terminal in a conforming product which has passed the test is cut away to thereby form a flexible printed wiring board of a product shape, and the flexible printed wiring board is put on a tray for shipping.

A common flexible wiring board will now be elaborated with reference to FIG. 4. This figure shows a common flexible printed wiring board 31 (hereafter referred to as, common FPC), a position 32 for picking up the test image chart, which corresponds to an image pickup area of the solid state image pickup element, and a terminal 33 for an electric test which is connected to the external connection terminal 3a or 3b in a circuit pattern so that an electric image pickup test is carried out.

Although the common FPC 31 has a rectangular shape in FIG. 4, the shape is not limited to a rectangle. When a shape such that an area of an FPC used according to the shape of a solid state image pickup device becomes the minimum and a portion to be cut away after completion of an electric image pickup test becomes the minimum is used, the cost of the common FPC 31 can be reduced.

In FIG. 4, legend 32 denotes the fixedly determined position for picking up a test image chart on the common FPC 31, that is, the solid state image pickup element 9 is attached to this position, and the test image chart is fixedly disposed on a rear face side of the common FPC 31, that is, in a position apart by a focal length on the other side.

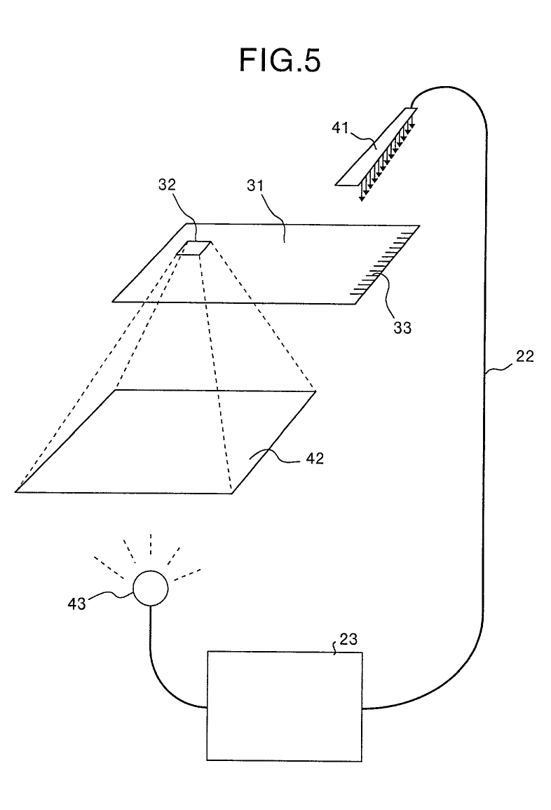

FIG. 5 shows a state of the electric image pickup test. This figure shows a test lead 22 for connecting the electric image pickup tester 23 and electric test terminal pins 41, a test image chart 42, and a light source 43.

FIG. 5 shows an example in which the test image chart 42 has a light transmitting characteristic. In this case, the illuminance of the test image chart 42 is set by emitting light to the back face of the test image chart 42. Although not shown in FIG. 5, it is also possible to emit light onto the face on which the test image chart 42 is picked up to thereby set the illuminance of the test image chart 42.

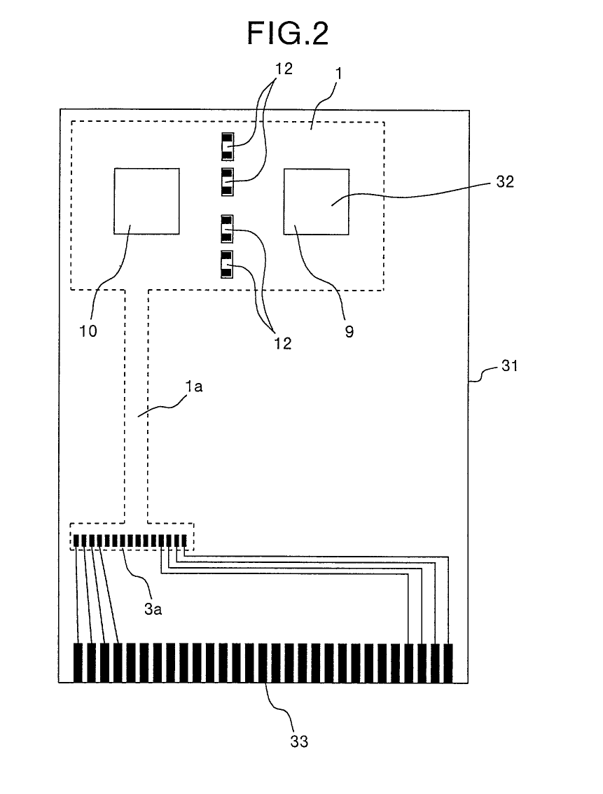

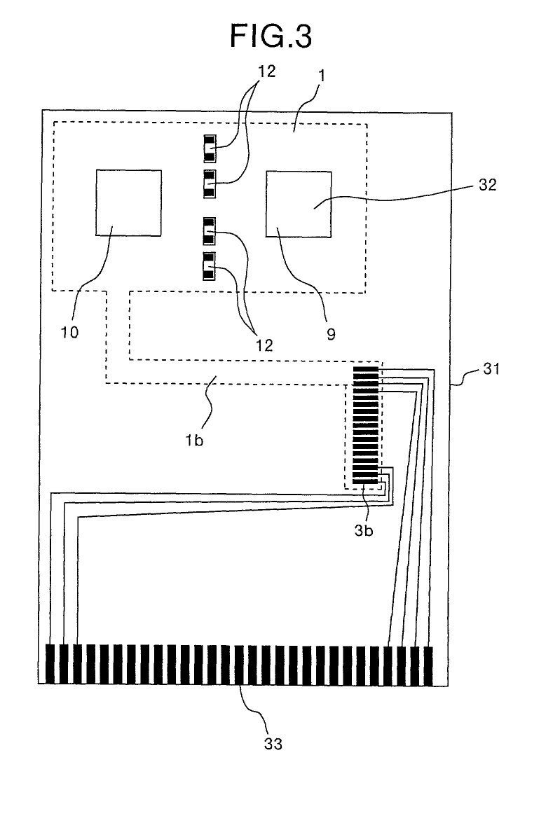

The electric image pickup test on the solid state image pickup device will be described by referring to FIG. 5. Although not illustrated in FIG. 5, a plurality of test image charts are provided on the outside and can be switched. In FIG. 5, the image of the test image chart 42 is picked up by the solid state image pickup element 9 in the position 32 of image pickup of the test image chart, optical image pickup information is converted to an electric image pickup signal by the solid state image pickup element 9, the electric image pickup signal is subjected to an image process by the IC parts 10 (refer to FIG. 2 and FIG. 3) or the like, and the resultant signal is outputted to the external connection terminal 3 (refer to FIG. 2 and FIG. 3). The signal is connected from the external connection terminal 3 via the printed wiring on the common FPC 31 to a land terminal of the electric test terminal 33. When the land terminal comes into contact with the electric test terminal pins 41, the signal is connected to the electric image pickup tester 23 via the lead 22 for test. A test on the image pickup apparatus is carried out in the following manner. The electric image pickup signal is transmitted to the electric image pickup tester 23, and the electric image pick up tester 23 determines whether the electric image pickup signal is proper or not with respect to the illuminance of the test image chart 42 corresponding to the brightness of the light source 43 set by the electric image pickup tester in accordance with a preset test standard.

In FIG. 4, the FPC 1 of single-sided printed wiring is presumed and the terminal 33 for electric test is shown on the front side face of the common FPC 31. In the case of using the FPC 31 of double-sided printed wiring, the terminal 33 for electric test may be mounted on the rear face of the common FPC 31.

It is preferable to mount the test 33 for electric test in such a manner that the area of the land portion for forming the terminal is large so that the terminal pins used for an electric test can be mounted with a margin and a pitch between lands is large so that the electric test terminal pins 41 (in FIG. 5) can easily and reliably come into contact with and can be electrically connected to the lands. Although the lands of the terminal 33 for electric test are arranged in a line in FIG. 4, the lands may be arranged in two or three lines. Further, the lands which form the terminal are not disposed together but may be dispersed.

Further, in determination of the placement of the terminal 33 for electric test, it is important that the external connection terminals 3a and 3b can be connected to the terminal 33 for electric test in the circuit pattern on the common FPC 31. By cutting away the wiring to the terminal 33 for electric test in the circuit pattern on the common FPC 31 after completion of the electric image pickup test, the solid state image pickup device can be manufactured.

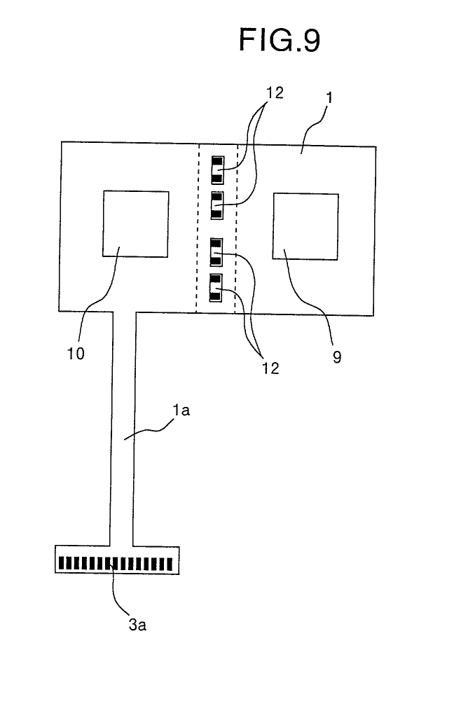

A second embodiment of the invention will be described below. FIG. 2 shows a case in which the solid state image pickup device shown in FIG. 9 is mounted on the common FPC 31. In FIG. 2, the position 32 of picking up the test image chart and the position of the solid state image pickup element 9 are overlapped with each other and are fixedly set so that an image of the test image chart can be picked up in the position.

Further, in FIG. 2, the terminal 33 for electric test and the external connection terminal 3a are connected via printed wiring on the common FPC 31. By the arrangement, even when the external connection terminal 3a is designated to have a shape corresponding to a very small connector (for example, an FPC connector of 0.3 mm pitches), the external connection terminal 3a can be connected to the land terminal of the terminal 33 for electric test via the wiring on the common FPC 31. Consequently, the external connection terminal 3a can be easily and reliably connected to the electric image pickup tester 23 (shown in FIG. 5) via the electric test terminal pins 41 (shown in FIG. 5) and an electric image pickup test can be conducted.

A solid state image pickup device can be manufactured from what is shown in FIG. 2 by cutting away all of the portion of the common FPC 31 except for the FPC 1 of the solid state image pickup device shown in FIG. 9. The broken line shows the shape of a product to be cut later. Since the other portion is the same as that described in the conventional technique, the description will not be repeated.

As shown in FIG. 2, even when the the FPC 1 has various shapes, by commonly setting the common FPC 31, the image pickup position 32 of the test image chart, and the terminal 33 for electric test, irrespective of the shapes of products, the electric test can be easily carried out by using the same test jig while switching a plurality of test image charts 42.

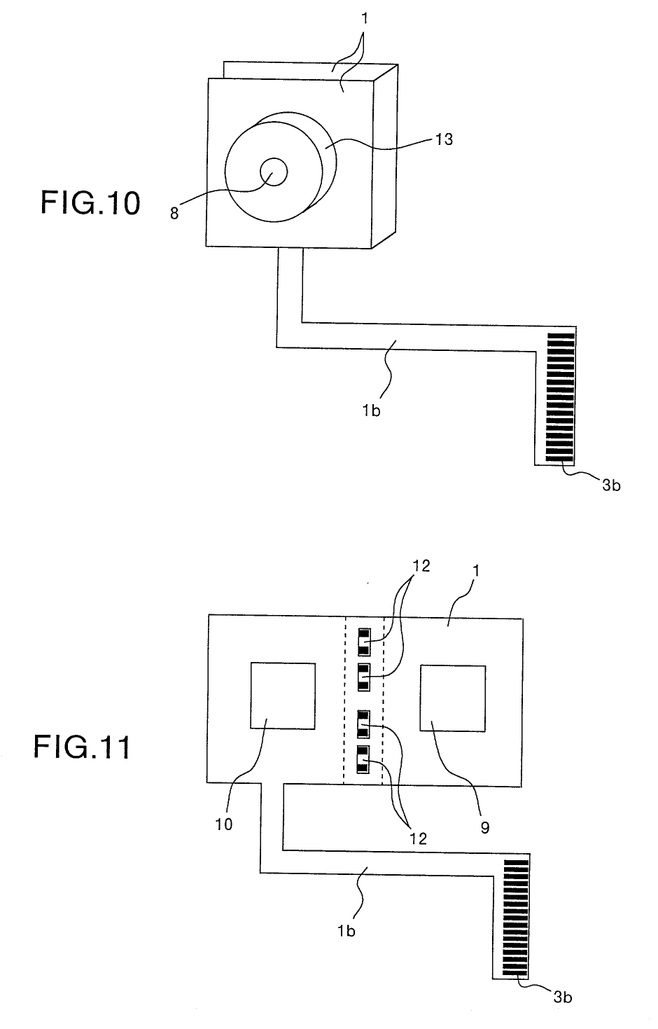

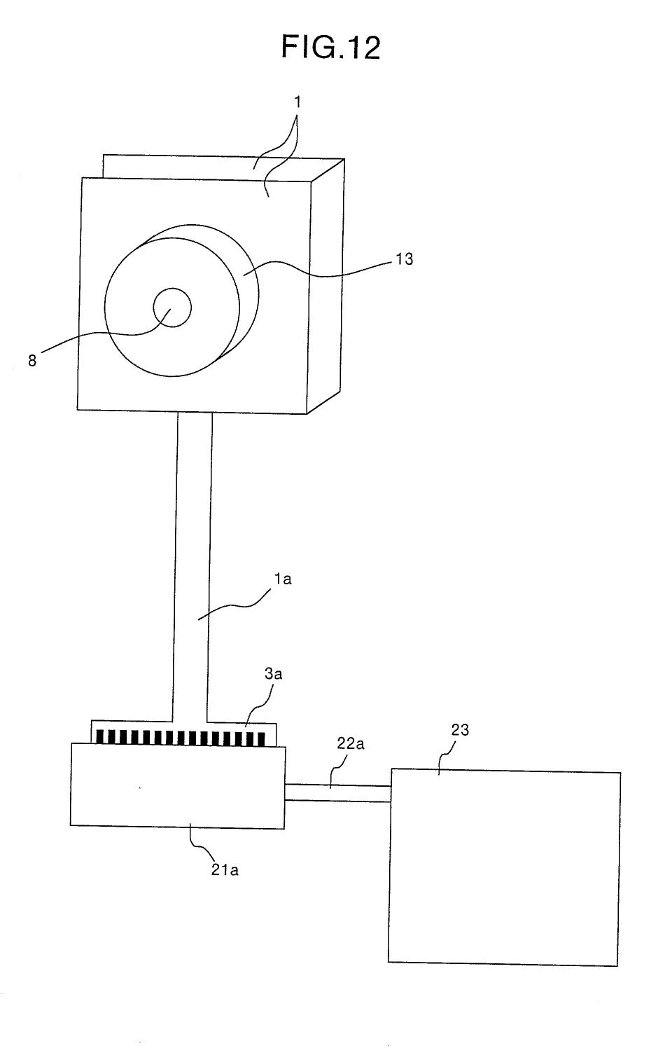

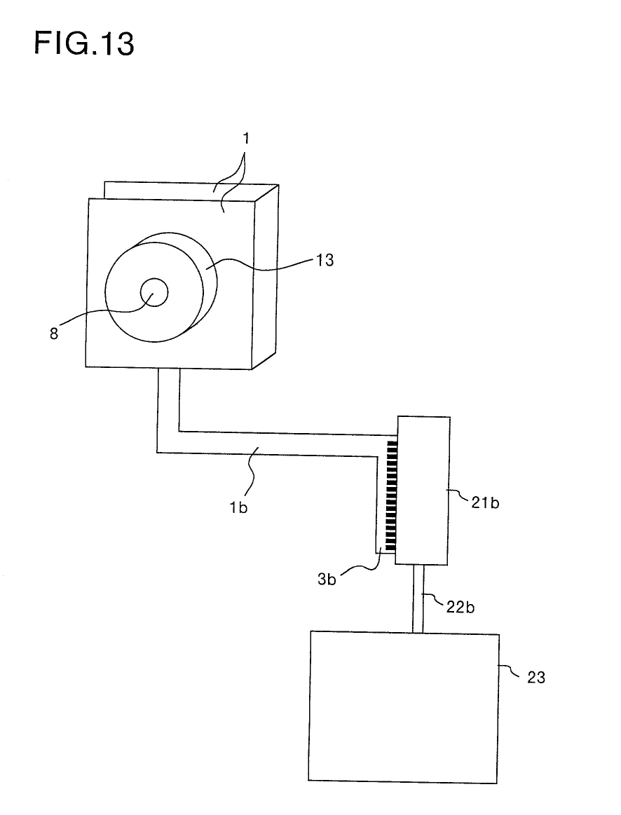

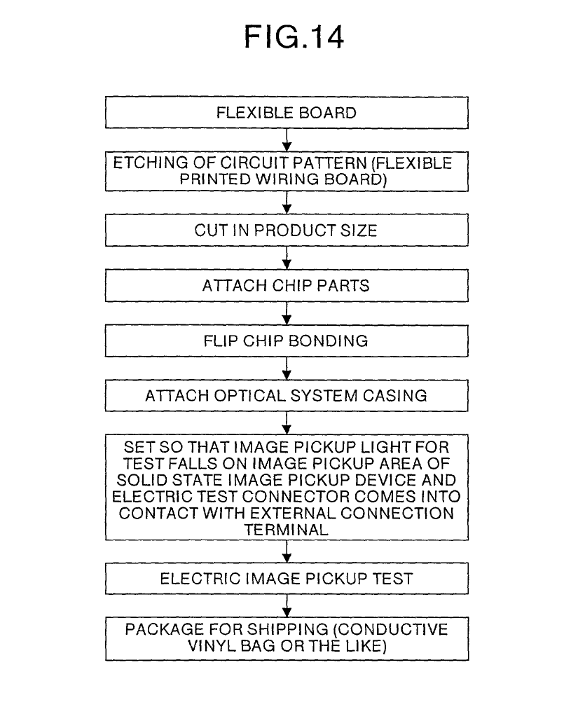

A third embodiment of the invention will be described below. FIG. 3 shows a case in which the solid state image pickup device shown in FIG. 11 is mounted on the common FPC 31. In FIG. 3, the image pickup position 32 of the test image chart and the position of the solid state image pickup element 9 are overlapped with each other and are fixedly set so that an image of the test image chart 42 can be taken in this position.

Further, in FIG. 3, the terminal 33 for electric test and the external connection terminal 3b are connected to each other via printed wiring on the common FPC 31. By the arrangement, even when the external connection terminal 3b is designated to have a shape corresponding to a very small connector (for example, an FPC connector of 0.3 mm pitches), the external connection terminal 3a can be connected to the land terminal of the terminal 33 for electric test by the wiring on the common FPC 31. Consequently, the external connection terminal 3b can be easily and reliably connected to the electric image pickup tester 23 (shown in FIG. 5) via the electric test terminal pins 4 (shown in FIG. 5) and an electric image pickup test can be carried out.

A solid state image pickup device can be manufactured from what is shown in FIG. 3 by cutting away all of the portion of the common FPC 31 except for the FPC 1 of the solid state image pickup device shown in FIG. 11. The broken line shows the shape of a product to be cut later. Since the other portion is the same as that described in the conventional technique, the description will not be repeated.

As shown in FIG. 3, even when the shapes of the FPC 1 are various, by commonly setting the common FPC 31, the image pickup position 32 of the test image chart, and the terminal 33 for electric test shown in FIG. 4, irrespective of the shape of a product, the electric test can be easily carried out while switching a plurality of test image charts 42 by using the same electric test jig.

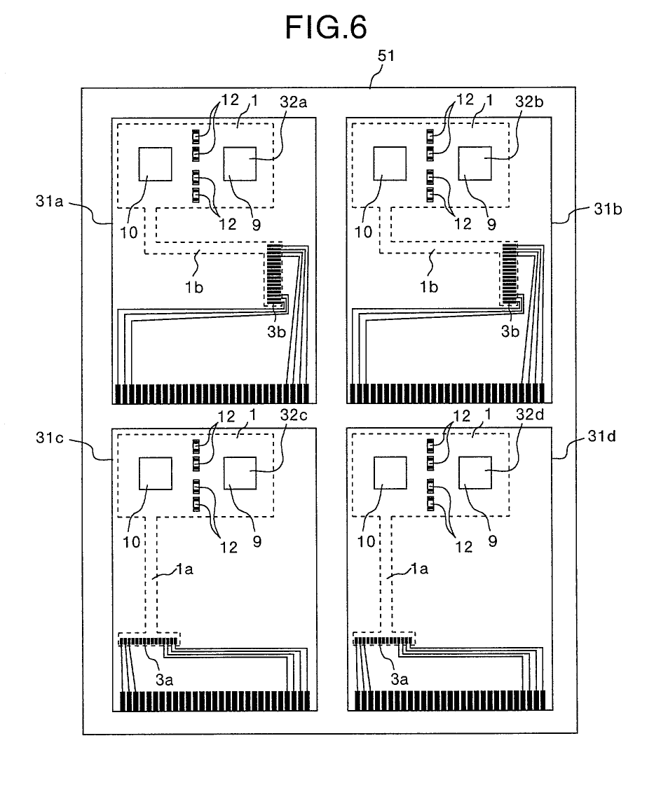

A fourth embodiment of the invention will be described below with reference to FIG. 6. FIG. 6 shows, as an example, a method of mounting four common FPCs 31a to 31d shown in FIG. 2 and FIG. 3 onto a tray 51 as an electric test jig and carriage jig and carrying out an electric image pickup test. As shown in this figure, the common FPCs 31a to 31d are mounted in positions where images of the test image charts 42 can be optically picked up in the test image chart pickup positions 32a to 32d (the same positions as the solid state image pickup elements 9). Further, the set position is fixed so that the land portion of the terminal 33 for electric test terminal can be electrically connected to the electric test terminal pins 41. Electric signals of the common FPCs 31a to 31d are captured by the electric test terminal pins 41 and connected to the electric image pickup tester 23 via the lead 22 for test. Meanwhile, power is supplied from the electric image pickup tester 23 to the light source 43 and the illuminance of the test image chart 42 is adjusted so as to be proper for testing the common FPCs 31a to 31d.

Although an example where the four common FPCs 31a to 31d are enclosed on the single tray 51 has been described, obviously, the number of common FPCs is not limited to four. The larger number of common FPCs may be enclosed or a single common FPC may be enclosed.

In FIG. 6, the size of each of the common FPCs 31a to 31d is set to the expected largest size of the FPC 1 so that the FPC 1 of any shape and having any number of terminals can be manufactured within the size. Further, the size of the jig for carriage capable of enclosing the common FPCs 31a to 31d is determined, an electric image pickup test is conducted, and after the test, an unnecessary portion including the terminal 33 for electric test in the common FPC 31 is cut away, thereby manufacturing solid state image pickup elements of various product shapes.

Although the solid state image pickup elements have various shapes, the tray 51 is commonly used, recesses are formed in the tray 51 in accordance with the shapes of the optical system casing 13 of the solid state image pickup device, the optical system casing 13 is fit in the recess so as to be fixed, and a cover for the tray is separately attached. In such a manner, by a structure that the FPC portion of the solid state image pickup device is sandwiched by the tray 51 and the cover of the tray, the device in the vertical direction can be also fixed.

When a reinforcing place is attached to the FPC 1, it is preferable to employ a structure in which the device in the vertical direction is fixed by sandwiching the portion of the reinforcing plate by the tray 51 and the cover of the tray. As the FPC used here, an FPC constructed by about 18.5 μm of copper foil, about 25 μm of polyimide, and about 25 μm of cover ray is generally used. For example, when the thickness of the reinforcing plate and adhesive is about 300 μm, it is sufficient to set the maximum gap between the tray 51 and its cover to about 368.5 μm.

Further, in FIG. 6, the thickness of each of the IC part 10 and the chip part 12 is usually about 500 μm. By adding the thickness of the parts and the thickness of the FPC 1 and further taking allowance and play into account, it is sufficient to set the thickness of the recess of the tray 51 to about 600 μm. In the area where there is no possibility that the parts are attached, for example, for the FPC lead portions 1A and 1B, a recess of only the thickness of the FPC 1 is sufficient.

Further, even after the FPC 1 is processed in a product shape shown in FIG. 9 or 11, the tray 51 can be used commonly as a jig for carriage.

Further, the cover of the tray is not necessarily used only for the corresponding jig for carriage. When a plurality of jigs for carriage are arranged, the cover of a tray can fix the neighboring solid state image pickup device.

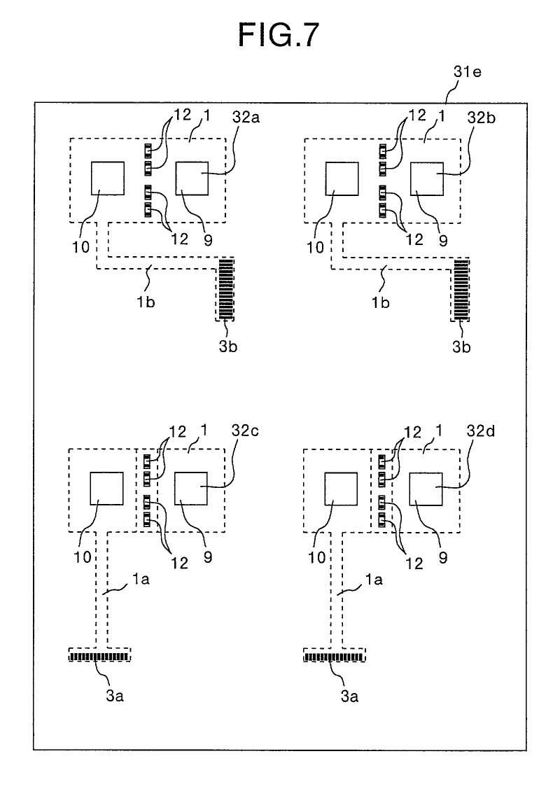

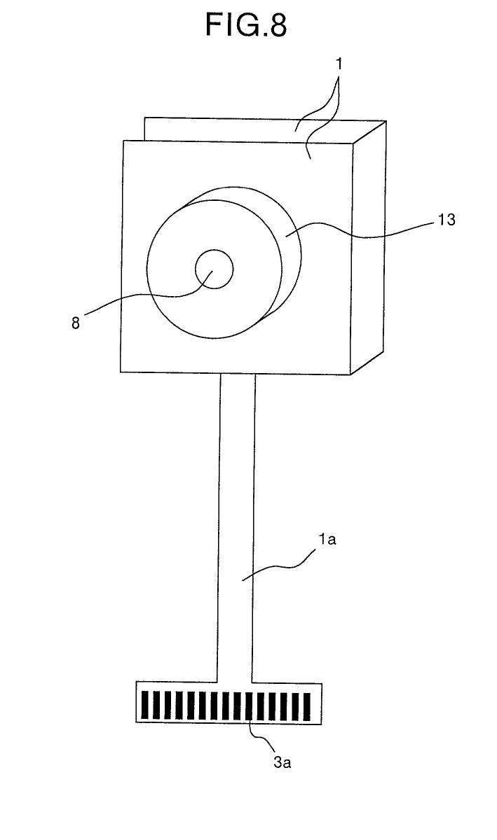

A fifth embodiment of the invention will be described below with reference to FIG. 7. In FIG. 7, four FPCs 1 are mounted on a single common FPC 31e. In this manner as well, the FPC 1, that is, a solid state image pickup device can be also manufactured in the above-described manner. Obviously, the number of the FPCs 1 mounted is not limited to four and kinds of the FPCs 1 may be variously combined.

As described above, according to the present invention, even if the lead portion and the connector and the number of terminals in the solid state image pickup device have various shapes, the positions of a plurality of test image charts and the electric test terminal pins in the electric image pickup test jig can be fixed. Consequently, an automatizer for mass production can commonly use the same equipment, mass production adapted for a portable telephone or the like can be realized, and the ratio of labor cost to the product cost can be reduced. Thus, a lower price can be realized and, further, investment in equipment can be suppressed.

In addition, the same tray is commonly used from the assembly process of the solid state image pickup device to the electric image pickup test and, moreover, even in a final product shape obtained by cutting away the unnecessary portion including the terminal for the electric test in the flexible printed wiring board, the tray can be continuously used. Consequently, the equipment adapted to an automatizer for mass production can be easily constructed, manual works can be reduced, mass production suitable for portable telephones and the like can be realized, and the ratio of labor cost to the product cost can be reduced. Thus, a lower price can be realized and, further, investment in equipment can be suppressed.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A method of manufacture of a solid state image pickup device comprising the steps of:
mounting a solid state image pickup element and an optical system casing on a common flexible printed wiring board;
constructing a terminal for an electric test on said common flexible printed wiring board; and
removing said terminal for electric test from said common flexible printed wiring board after completion of the electric test.

2. The method of manufacturing a solid state image pickup device according to claim 1, wherein the electric test is an electric image pickup test, and said solid state image pickup element is attached to a fixed position on said common flexible printed wiring board irrespective of a shape of said solid state image pickup device.

3. The method of manufacturing a solid state image pickup device according to claim 1, wherein said terminal for electric test is attached to a fixed position on said common flexible printed wiring board irrespective of a shape of said solid state image pickup device.

4. The method of manufacturing a solid state image pickup device according to claim 1, wherein a test jig used at the time of carrying out the electric test can be also used as a jig for carriage.

5. The method of manufacturing a solid state image pickup device according to claim 4, wherein said jig for carriage which can be also used as said test jig has a recess in a portion of said optical system casing to fix said solid state image pickup device.

6. The method of manufacturing a solid state image pickup device according to claim 4, wherein said jig for carriage which can be also used as said test jig separately has a cover and fixes said solid state image pickup device so as to sandwich said solid state image pickup device by said jig and said cover.

7. A flexible printed wiring board for mounting at least one solid state image pickup device, which solid state image pickup device having,
a solid state image pickup element and an optical system casing mounted on said flexible printed wiring board;
a terminal prepared on said flexible printed wiring board, which terminal is exclusively used when performing an electric test; and
cutting lines marked on said common flexible printed wiring board in such a manner that, when cut along said cutting lines, said flexible printed wiring board is divided into at least portion(s)
a) corresponding to each mounted solid state image pickup device(s), and
b) a portion that said terminal used when performing the electric test.
